(19) United States
(12) Patent Application Publication
(10) Pub. No.: US 2023/0024412 A1
(43) Pub. Date: Jan. 26, 2023

(54) LIGHT CONTROL FILM AND A METHOD OF MANUFACTURING THE SAME

(71) Applicant: 3M INNOVATIVE PROPERTIES COMPANY, St. Paul, MN (US)

(72) Inventors: James E. Lockridge, St. Paul, MN (US); Kevin W. Gotrik, Hudson, WI (US); Raymond J. Kenney, Woodbury, MN (US); Caleb T. Nelson, McKinney, TX (US); Daniel J. Schmidt, Woodbury, MN (US); Riley J. Hillstrom, North Hudson, WI (US)

(21) Appl. No.: 17/757,329

(22) PCT Filed: Dec. 17, 2020
(86) PCT No.: PCT/IB2020/062133

§ 371 Date: Jun. 14, 2022

Related U.S. Application Data
(60) Provisional application No. 62/951,794, filed on Dec. 20, 2019.

(51) Int. Cl. G02B 5/02; G02B 5/00; B05D 5/06; B05D 3/04; B05D 3/02

(52) U.S. Cl. CPC G02B 5/0294; G02B 5/003; B05D 5/06; B05D 3/0406; B05D 3/0263; B05D 3/0272

(57) ABSTRACT

The present disclosure provides a light control film and a method of manufacturing the same. The method includes providing a microstructured film. The microstructured film includes a plurality of light transmissive regions alternated with channels. The microstructure film is defined by a top surface and a pair of side surfaces of each light transmissive region and a bottom surface of each channel. The method further includes coating the pair of side surfaces of each light transmissive region and the bottom surface of each channel with a coating. The coating includes light absorbing particles that are dispersed in a liquid. The method further includes drying the coating such that the light absorbing particles are selectively deposited on the pair of sides surfaces of each light transmissive region.

### TECHNICAL FIELD

This invention relates to light control films and a method of manufacturing the same.

### BACKGROUND

Light control film (LCF), also known as “privacy film,” is an optical film that regulates the transmission of light. Various LCFs are known, and typically include a light transmissive film having a plurality of parallel louvers. The louvers are formed of a light absorbing material.

LCFs can be placed proximate a display surface, image surface, or any other surface to be viewed. At normal incidence, (i.e., 0 degree viewing angle) where a viewer is looking at an image through the LCF in a direction that is perpendicular to the film surface, the image is viewable. As the viewing angle increases, the amount of light transmitted through the LCF decreases until a viewing cut-off angle is reached where substantially all the light is blocked by the light-absorbing material and the image is no longer viewable. This can provide privacy to a viewer by blocking observation by others that are outside a typical range of viewing angles.

LCFs may have low on-axis transmission due to absorption of light by the light absorbing material. Several efforts have been directed at improving the on-axis transmission of LCFs. For example, an aspect ratio of the LCF can be increased to decrease a thickness of the light absorbing material. However, conventional micro-replication methods are not feasible to provide high aspect ratio LCFs.

### SUMMARY

The present invention relates to light control films and method of manufacturing the same. The present invention also relates to light control films for use with optical applications.

In one embodiment of the present disclosure, a method of manufacturing a light control film is provided. The method includes providing a microstructured film. The microstructured film includes a plurality of light transmissive regions alternated with channels. The microstructure film is defined by a top surface and a pair of side surfaces of each light transmissive region, and a bottom surface of each channel. The method further includes coating the pair of side surfaces of each light transmissive region and the bottom surface of each channel with a coating. The coating includes light absorbing particles that are dispersed in a liquid. The method further includes drying the coating such that the light absorbing particles are selectively deposited on the pair of sides surfaces of each light transmissive region.

In some embodiments, the coating is a water-based coating and the liquid is water.

In some embodiments, the top surface of each light transmissive region and the bottom surface of each channel are devoid of the light absorbing particles.

In some embodiments, the light absorbing particles have an average particle size of at least 20 nm.

In some embodiments, the light absorbing particles have an average particle size of at least 1 micron.

In some embodiments, the drying of the coating is achieved by at least one of air drying, infra-red heating, and oven drying.

In some embodiments, the drying of the coating is achieved at a temperature of at least 50° C.

In some embodiments, the method further includes performing a surface treatment on the surface of the microstructured film. Further, in some embodiments, the surface treatment includes at least one of oxygen plasma treatment, corona treatment, and fluorocarbon plasma treatment.

In some embodiments, the microstructured film is devoid of any surface treatment.

In some embodiments, the method further includes filling the channels of the microstructured film with a material similar to a material of the light transmissive regions.

In some embodiments, the coating includes an additive.

In some embodiments, the additive includes at least one of a binder, a surfactant, and a cross-linker.

In some embodiments, the binder includes at least one of an anionic binder, a cationic binder, and a zwitterionic binder.

In some embodiments, the light absorbing particles includes carbon black particles.

In some embodiments, the light absorbing particles are present in a concentration of at least 1 wt. % based on the total weight of the coating.

In some embodiments, the microstructured film further includes a base layer. The light transmissive regions extend from the base layer.

In some embodiments, the microstructured film includes a polymerizable resin.

In another embodiment, a method of manufacturing a light control film is provided. The method includes providing a microstructured film. The microstructured film includes a plurality of light transmissive regions alternated with channels. The microstructure film is defined by a top surface and a pair of side surfaces of each light transmissive region, and a bottom surface of each channel. The method further includes performing a first surface treatment followed by selectively performing a second surface treatment on the top surface of each light transmissive region and the bottom surface of each channel. The method further includes coating the pair of side surfaces of each light transmissive region and the bottom surface of each channel with a coating. The coating includes light absorbing particles that are dispersed in a liquid. The method further includes drying the coating such that the light absorbing particles are selectively deposited on the pair of sides surfaces of each light transmissive region.

In some embodiments, the first surface treatment includes oxygen plasma treatment or corona treatment.

In some embodiments, the second surface treatment includes fluorocarbon plasma treatment.

In some embodiments, the coating is a water-based coating and the liquid is water.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the figures refer to like components. When pluralities of similar elements are present, a single reference numeral may be assigned to each plurality of similar elements with a small letter designation referring to specific elements. When referring to the elements collectively or to a non-specific one or more of the elements, the small letter designation may be eliminated. However, it will be understood that the use of a numeral to refer to a component in a given figure is not intended to limit the component in another figure labeled with the same number.

FIG. 1A is a cross-sectional view of an embodied light control film;

FIG. 1B depicts the polar cut-off viewing angle of the light control film of FIG. 1A;

FIG. 2 is a perspective view of a microstructured film;

FIGS. 3A-3E are cross-sectional schematics of an exemplary method of manufacturing a light control film;

FIG. 4 is a flowchart for a method of manufacturing the microstructured film according to an embodiment of the present disclosure;

FIG. 5 is a flowchart for a method of manufacturing the microstructured film according to another embodiment of the present disclosure;

FIGS. 6A and 6B show a method of performing a surface treatment on the surface of the microstructured film; and

FIG. 7 depicts a plot of transmission as a function of viewing angle for various coating compositions of the light control film.

### DETAILED DESCRIPTION

In the following description, reference is made to the accompanying figures that form a part thereof and in which various embodiments are shown by way of illustrations. It is to be understood that other embodiments are contemplated and may be made without departing from the scope or spirit of the present disclosure. The following detailed description, therefore, is not to be taken in a limiting sense.

In the context of present disclosure, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 wt. % of the first and second materials are identical and any variation between the first and second materials comprises less than about 10 wt. % of each of the first and second materials.

The present disclosure is directed to light control films and manufacturing the same. The microstructured film includes a plurality of light transmissive regions alternated with channels. The microstructured film is defined by a top surface and a pair of side surfaces of each light transmissive region, and a bottom surface of each channel. The method further includes coating the pair of side surfaces of each light transmissive region and the bottom surface of each channel with a coating. The coating includes light absorbing particles that are dispersed in a liquid. In some embodiments, the coating is a water-based coating and the liquid is water. The method further includes drying the coating such that the light absorbing particles are selectively deposited on the pair of sides surfaces of each light transmissive region. The light control films have various applicability, such as displays, windows, and so forth.

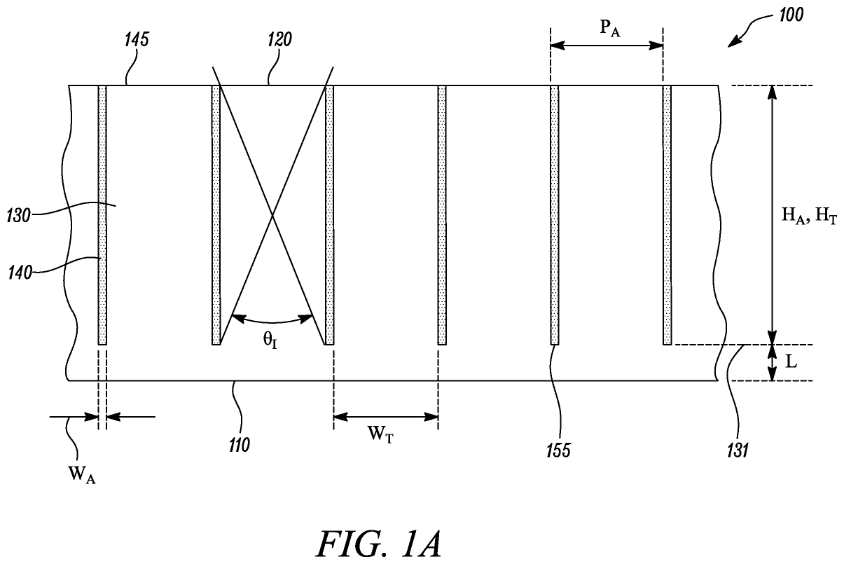

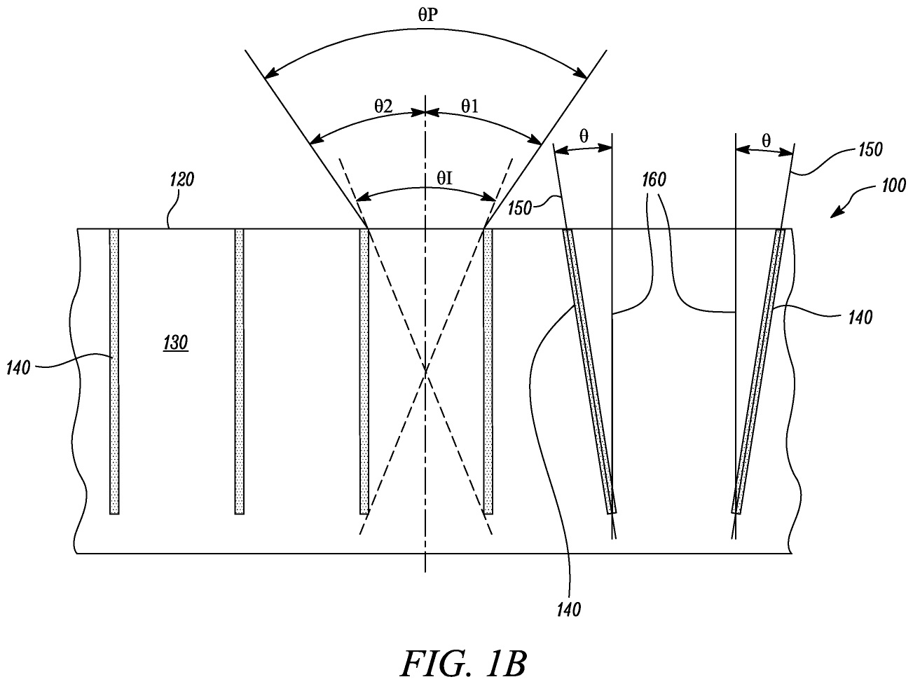

FIG. 1A shows a perspective view of an exemplary light control film (“LCF”). In an embodiment, the LCF 100 has a high aspect ratio. The LCF includes a light input surface 110 and a light output surface 120 opposite to the light input surface 110. The light output surface 120 is typically parallel to the light input surface 110. The LCF 100 includes alternating light transmissive regions 130 (interchangeably referred to as “transmissive regions 130”) and light absorptive regions 140 (interchangeably referred to as “absorptive regions 140”) disposed between the light output surface 120 and a light input surface 110.

As depicted in FIG. 1A, the transmissive regions 130 are typically integral with a land region L, meaning that there is no interface between the land region and a base portion 131 of the transmissive regions 130. Alternatively, LCF may lack such land region L or an interface may be present between the land region L, and the transmissive regions 130. Typically, the land region L is disposed between the alternating transmissive regions 130 and absorptive regions 140, and the light input surface 110.

Alternatively, in some aspect, the surface 120 may be the light input surface and the surface 110 may be the light output surface. In such cases, the land region is disposed between the alternating transmissive regions 130 and absorptive regions 140 and the light output surface.

The transmissive regions 130 can be defined by a width W_{T}. Excluding the land region L, the transmissive regions 130 typically have nominally the same height as the absorptive regions 140. In this aspect, a height of the absorptive regions H_{A} is at least 30, 40, 50, 60, 70, 80, 90 or 100 microns. In some case, the height H_{A} is no greater than 200, 190, 180, 170, 160, or 150 microns. In some cases, the height H_{A} is no greater than 140, 130, 120, 110, or 100 microns. The LCF 100 typically includes a plurality of the transmissive regions 130 having nominally the same height and width. In some cases, the transmissive regions 130 have a height H_{T}, a maximum width at its widest portion W_{T}, and an aspect ratio H_{T}/W_{T} of at least 1.75. In some embodiments, H_{T}/W_{T} is at least 2.0, 2.5, 3.0, 3.5, 4.0, 4.5 or 5.0. In another aspect, the aspect ratio of the transmissive regions 130 is at least 6, 7, 8, 9, 10. In another aspect, the aspect ratio of the transmissive regions 130 is at least 15, 20, 25, 30, 35, 40, 45, or 50.

The absorptive regions 140 have the height H_{A} defined by the distance between a bottom surface 155 and a top surface 145, such top and bottom surfaces 145, 155 typically being parallel to the light output surface 120 and the light input surface 110. The absorptive regions 140 have a maximum width W_{A} and are spaced apart along the light output surface 120 by a pitch P_{A}.

The width of the absorptive regions W_{A} at the base (i.e., adjacent to the bottom surface 155) is typically nominally the same as the width of the absorptive regions 140 adjacent to the top surface 145. However, when the width of the absorptive regions at the base differs from the width adjacent the top surface, the width is defined by the maximum width. The maximum width of a plurality of absorptive regions can be averaged for an area of interest, such as an area in which the transmission (e.g., brightness) is measured. The absorptive regions 140 of the LCF 100 typically have nominally the same height and width. The absorptive regions 140 generally have a width no greater than 10, 9, 8, 7, 6, 5, 4, 3, 2, or 1 micron. The absorptive regions 140 generally have a width no greater than 900, 800, 700, 600, or 500 nanometers and have a width of at least 50, 60, 70, 80, 90, or 100 nanometers.

An absorptive region 140 can be defined by an aspect ratio, the height of the absorptive region divided by the maximum width of the absorptive region (H_{A}/W_{A}). Typically, the aspect ratio of the absorptive regions is at least 1, 2, 3, 4, 5, 6, 7, 8, 9, or 10. In some aspects, the height and width of the absorptive region(s) are selected such that the absorptive region(s) 140 have an even higher aspect ratio. In some cases, the aspect ratio of the absorptive regions is at least 25 15, 20, 25, 30, 35, 40, 45, 50, 55, 60, 65, 70, 75, 80, 85, 90, 95 or 100. In another case, the aspect ratio of the absorptive regions is at least 200, 300, 400, or 500. The aspect ratio can range up to 10,000 or greater. In some cases, the aspect ratio is no greater than 9,000; 8,000; 7,000; 6,000, 5,000; 4,000, 3000; 2,000, or 1,000.

As shown in FIG. 1B, the LCF 100 includes alternating transmissive regions 130 and absorptive regions 140, and an interface 150 between the transmissive regions 130 and the absorptive regions 140. The interface 150 forms a wall angle θ with line 160 that is perpendicular to the light output surface 120. Larger wall angles θ decrease transmission at normal incidence or in other words a viewing angle of 0 degrees. Smaller wall angles are preferred such that the transmission of light at normal incidence can be made as large as possible. Typically, the wall angle θ is less than 10, 35 9, 8, 7, 6, or 5 degrees. More particularly, the wall angle θ is no greater than 2.5, 2.0, 1.5, 1.0, 0.5, or 0.1 degrees. In the illustrated embodiment, the wall angle θ is zero or approaching zero. When the wall angle θ is zero, the angle between the absorptive regions 140 and the light output surface 120 is 90 degrees. Depending on the wall angle θ, the transmissive regions 130 can have a rectangular or trapezoidal cross-section.

The transmission (e.g., brightness of visible light) can be increased when incident light undergoes total internal reflection (TIR) from the interface between the absorptive and transmissive regions 140, 130. Whether a light ray will undergo TIR or not, can be determined from the incidence angle with the interface, and the difference in refractive index of the materials of the transmissive and absorptive regions 130, 140.

As shown in FIG. 1B, the transmissive regions 130 between the absorptive regions 140 have an interface angle θI defined by the geometry of the alternating transmissive regions 130 and absorptive regions 140. As depicted in FIGS. 1A and 1B, the interface angle θI can be defined by the intersection of two lines. The first line extends from a first point, defined by the bottom surface and the side wall surface of a first absorptive region 140, and a second point defined by the top surface and side wall surface of the nearest second absorptive region 140. The second line extends from a first point defined, by the top surface and the side wall surface of the first absorptive region 140, and a second point, defined by the bottom surface and side wall surface of the second absorptive region 140.

In some cases, a polar cut-off viewing angle θP is equal to the sum of a polar cut-off viewing half angle θ1 and a polar cut-off viewing half angle θ2 each of which are measured from the normal to the light input surface 110. In some cases, the polar cut-off viewing angle θP is symmetric, and the polar cut-off viewing half angle θ1 is equal to the polar viewing half angle θ2. Alternatively, the polar cut-off viewing angle θP can be asymmetric, and the polar cut-off viewing half angle θ1 is not equal to the polar cut-off viewing half angle θ2.

The light control film 100 described herein may have any desired polar viewing cutoff angle θP. In one aspect, the polar viewing cutoff angle θP ranges from 40° to 90° or even higher. The polar viewing cutoff angle θP can be determined by the various parameters, i.e., H_{A}, W_{A}, W_{T}, P_{A}, and indices of refraction of the materials of the light control film 100.

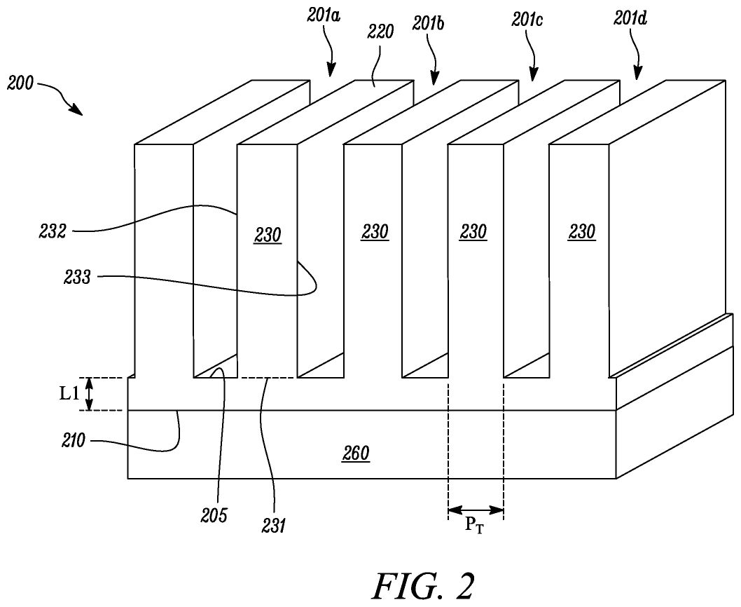

FIG. 2 illustrates a microstructured film 200 according to an embodiment of the present disclosure. The microstructured film 200 is coated to make an LCF. As shown in FIG. 2, the microstructured film 200 includes a microstructured surface that includes a plurality of channels 201a-201d (collectively referred to as “the channels 201”) on a base layer 260. The microstructured surface is disposed on a top surface 210 of the base layer 260. Further, a continuous land layer L1 can be present between a bottom surface 205 of the channels 201 and the top surface 210 of the base layer 260. Alternatively, the channels 201 can extend all the way through the microstructured film 200. In another aspect (not shown), the bottom surface 205 of the groove or channels 201 can be coincident with the top surface 210 of the base layer 260. The microstructured film 200 further includes a plurality of light transmissive regions 230 extending from the continuous land layer L1. In some case, the base layer 260 is a preformed film that includes a different organic polymeric material than the light transmissive regions 230 as will subsequently be described.

In the illustrated embodiment, the light transmissive regions 230 are protrusions. The height and width of the light transmissive regions 230 are defined by adjacent channels (e.g., 201a and 201b). The light transmissive regions 230 can be defined by a top surface 220, a bottom surface 231, and a pair of side surfaces 232 and 233 that join the top surface 220 to the bottom surface 231. The microstructured film 200 has a surface defined by the top surface 220 and the pair of side surfaces 232, 233 of each light transmissive region 230, and a bottom surface 205 of each channel 201.

In some cases, the side surface 232, 233 can be parallel to each other. Alternatively, each of the side surfaces 232, 233 have a tapered profile. Further, the tapered profile of each of the side surfaces 232, 233 tapers towards the top surface 220 of the microstructured film 200. Alternatively, the side surfaces 232, 233 may have a straight profile. Further, a cross-section of each of the plurality of light transmissive regions 230 includes at least one of a square shape, a rectangular shape, a curved shape, a trapezoidal shape, and a polygonal shape. In the illustrated embodiment, the light transmissive regions 230 have a rectangular shape. The light transmissive regions 230 may be equally spaced apart from each other.

In some embodiments, the light transmissive regions 230 are micro-replicated on the base layer 260. An exemplary micro-replication process is described in U.S. Pat. No. 8,503,122 B2 (Liu et al.). A typical micro-replication process includes depositing a polymerizable composition onto a master negative micro-structured molding surface in an amount enough to fill the cavities of the master. The cavities are then filled by moving a bead of the polymerizable composition between a preformed base and the master. The composition is then cured. The light transmissive regions 230 may be formed on the base layer 260 by various methods, such as extrusion, cast-and-cure, coating or some other method.

In some cases, the protrusions (e.g., light transmissive regions 230) have a pitch PT of at least 10 microns. The pitch PT is the distance between the onset of a first protrusion (e.g. transmissive region) and the onset of a second protrusion (e.g. transmissive region) as depicted in FIG. 2. The pitch PT may be at least 15, 20, 25, 30, 35, 40, 45, or 50 microns. The pitch PT is generally no greater than 1 mm. The pitch PT is s typically no greater than 900, 800, 700, 600, or 500 microns. In some cases, the pitch PT is typically no greater than 550, 500, 450, 400, 350, 300, 250 or 200 microns. In some embodiments, the pitch PT is no greater than 175, 150, 100 microns. In some case, the protrusions are evenly spaced, having a single pitch. Alternatively, the protrusions may be spaced such that the pitch between adjacent protrusions is not the same.

In some cases, the light transmissive regions 230 are made of a polymerizable resin. In some cases, the polymerizable resin may be optically clear having a substantially high transmission in a wavelength range from about 300 nanometers (nm) to about 800 nm. The polymerizable resin may include a combination of a first polymerizable component and a second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition may include a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof. The polymerizable resin can be a radiation curable polymeric resin, such as a UV curable resin. More particularly, the cast-and-cure process was used via UV-crosslinking of an acrylate resin against a custom tool. The tool was made with a “square wave” design, meaning that the pitch was approximately equal to the widths of the channels.

A microstructure-bearing article (e.g., the microstructured film 200 as shown in FIG. 2) can be prepared by any suitable method. In one aspect, the microstructure-bearing article (e.g., the microstructured film 200 shown in FIG. 2) can be prepared by a method including the steps of (a) preparing a polymerizable composition; (b) depositing the polymerizable composition onto a master negative microstructured molding surface (e.g. tool) in an amount barely sufficient to fill the cavities of the master; (c) filling the cavities by moving a bead of the polymerizable composition between a (e.g. preformed film) base layer and the master, at least one of which is flexible; and (d) curing the composition. The deposition temperature can range from ambient temperature to about 180° F. (82° C.). The master can be metallic, such as nickel, chrome- or nickel-plated copper or brass, or can be a thermoplastic material that is stable under the polymerization conditions and has a surface energy that allows clean removal of the polymerized material from the master. When the base layer is a preformed film, one or more of the surfaces of the film can optionally be primed or otherwise be treated to promote adhesion with the organic material of the light transmissive regions.

The polymerizable composition may include a combination of a first and second polymerizable component selected from (meth)acrylate monomers, (meth)acrylate oligomers, and mixtures thereof. As used herein, “monomer” or “oligomer” is any substance that can be converted into a polymer. The term “(meth)acrylate” refers to both acrylate and methacrylate compounds. In some cases, the polymerizable composition can include a (meth)acrylated urethane oligomer, (meth)acrylated epoxy oligomer, (meth)acrylated polyester oligomer, a (meth)acrylated phenolic oligomer, a (meth)acrylated acrylic oligomer, and mixtures thereof.

The base layer materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefin-based material such as cast or orientated films of polyethylene, polypropylene, and polycyclo-olefins, polyimides, and glass. Optionally, the base layer 260 can contain mixtures or combinations of these materials. In some embodiments, the base layer may be multi-layered or may contain a dispersed component suspended or dispersed in a continuous phase.

Examples of base layer materials include polyethylene terephthalate (PET) and polycarbonate (PC). Examples of useful PET films include photograde polyethylene terephthalate, available from DuPont Films of Wilmington, Del. under the trade designation “Melinex 618”. Examples of optical grade polycarbonate films include LEXAN® polycarbonate film 8010, available from GE Polymershapes, Seattle Wash., and Panlite 1151, available from Teijin Kasei, Alpharetta Ga.

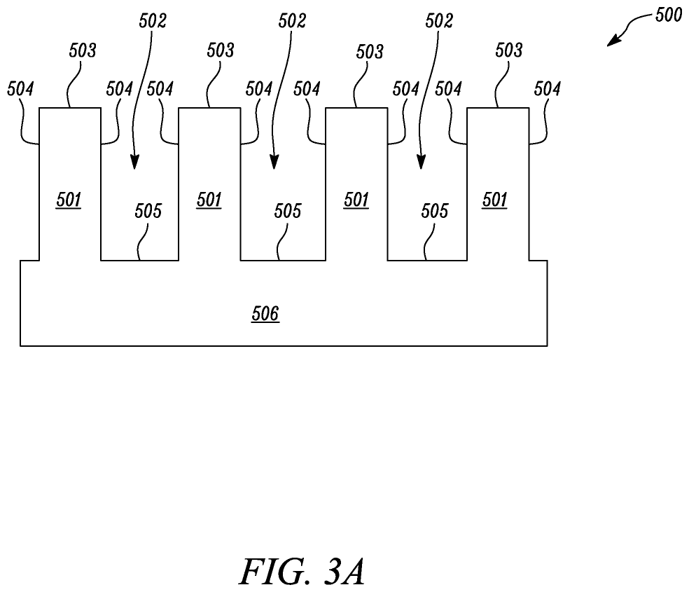

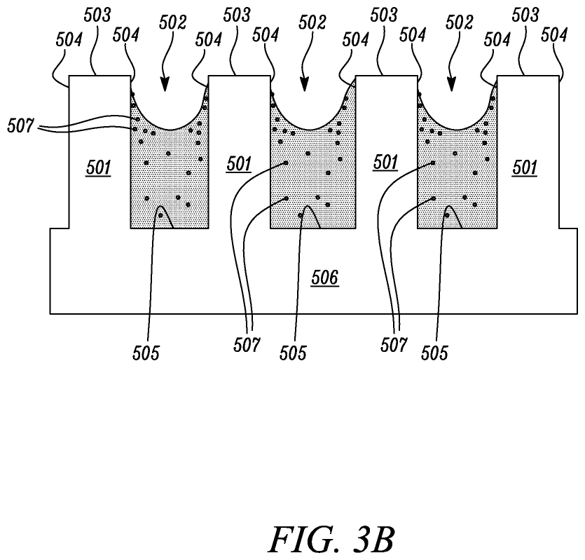

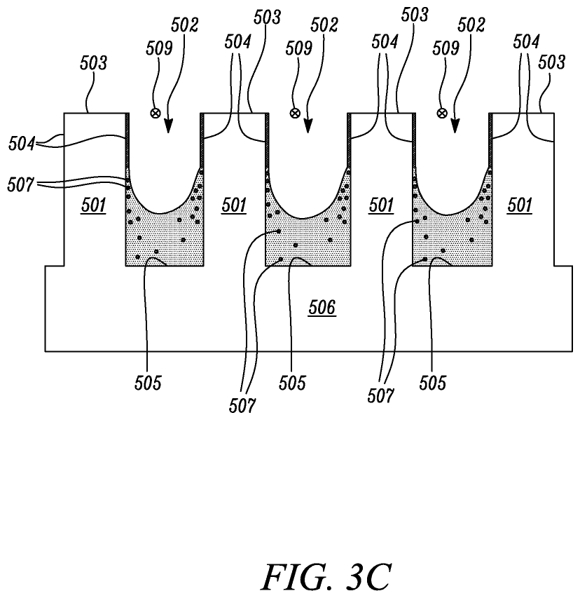

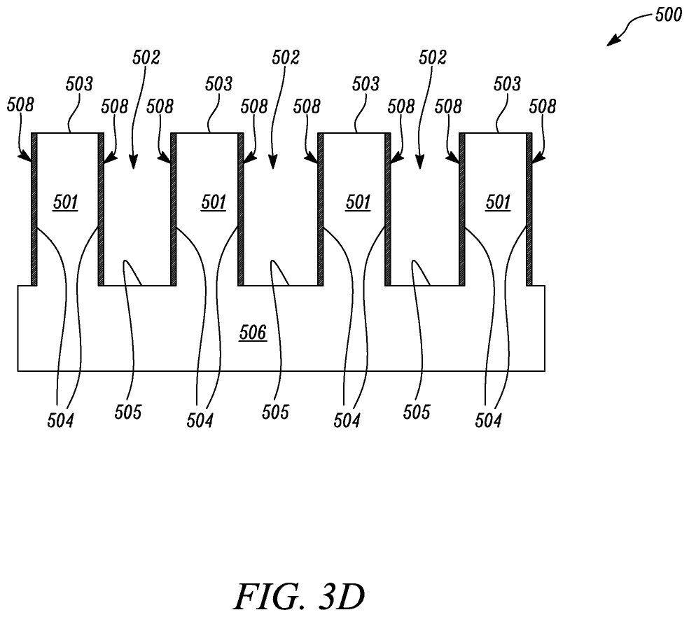

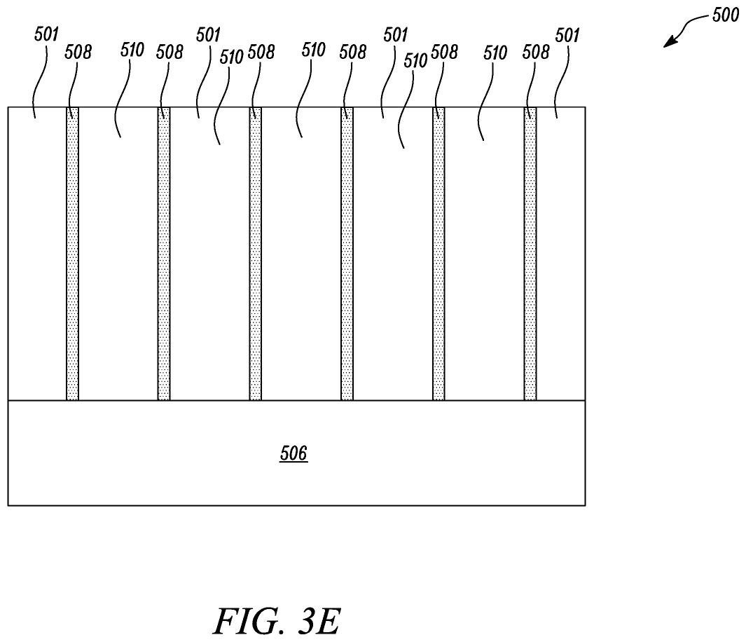

FIGS. 3A-3E illustrate a method of manufacturing a light control film. FIG. 3A depicts a microstructured film 500. The microstructured film 500 includes light transmissive regions 501. A channel 502 is defined between adjacent light transmissive regions 501. Each light transmissive region 501 has a top surface 503 and a pair of side surfaces 504. Each channel 502 has a bottom surface 505. The bottom surface 505 of each channel 502 coincides with a base layer 506 of the microstructured film 500.

FIG. 3B depicts coating of the side surfaces 504 of channels 502. Each channel 502 is coated with a coating that includes light absorbing particles 507 dispersed in a liquid. In some embodiments, the coating is a water-based coating the liquid is water. Specifically, the light absorbing particles 507 are disposed in water.

In some cases, the water-based coating includes an additive. The additive may be a binder, a surfactant, a cross-linker, or a combination thereof. In some cases, the binder may be an anionic binder, a cationic binder, or a zwitterionic binder. Suitable examples of binders include polyurethane, poly(vinyl alcohol), polyester, polyester-melamine, sulfonated polyester, fluoropolymer, polyacrylate, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and salts thereof. Various surfactants may be used in combination with the light absorbing particles 507.

Suitable non-ionic or amphoteric surfactants include surfactants which are fluorinated alkyl polyoxyethylene ethanols; fluorinated alkyl alkoxylates; fluorinated alkylesters; alkyl polyethylene oxides; alkyl phenyl polyethylene oxides; acetylenic polyethylene oxides; polyethylene oxide block copolymers; amines, amides, esters (such as fatty acid esters) and diesters of polyethylene oxide; sorbitane fatty acid esters; glycerine fatty acid esters; fluorinated alkyl amphoteric mixture; polyethersiloxane copolymer; organo-modified polysiloxane; dimethyl-polysiloxane blends. Suitable ionic surfactants include anionic surfactants selected from ammonium perfluoroalkyl sulfonates; lithium perfluoroalkyl sulfonates; potassium perfluoroalkyl sulfonates; fatty acid salts; alkyl sulfate ester salts; alkylaryl sulfonate salts dialkyl sulfosuccinate salts, alkyl phosphate ester salts and polyoxy ethylenealkyl sulfate ester salts. Suitable cationic surfactants include fluorinated alkyl quaternary ammonium iodides.

In some cases, the light absorbing particles 507 may be provided in combination with cross-linkers. The selection of crosslinker will depend on the surface functionality of the light-absorbing particles and therefore may be selected from materials that are typically known for such application. The following are examples of materials that may be used: aziridines, carbodiimides, isocyanates, melamines, epichorohydrins, polycations, polyanions.

Light absorbing materials useful for forming the light absorbing particles 507 can be any suitable material that functions to absorb or block light at least in a portion of the visible spectrum. Preferably, the light absorbing material can be coated or otherwise provided on the side surfaces 504 of the light transmissive regions 501 to form light absorbing regions in the LCF. Exemplary light absorbing materials include a black or other light absorbing colorant (such as, carbon black or another pigment or dye, or combinations thereof). Other light absorbing materials can include particles or other scattering elements that can function to block light from being transmitted through the light absorbing regions.

Various commercially available pigments may be used as materials for the light absorbing particles 507. For example, suitable pigments are available commercially as colloidally stable water dispersions from manufacturers such as Cabot, Clariant, DuPont, Dainippon and DeGussa. Particularly suitable pigments include those available from Cabot Corporation under the CAB-O-JET® name, for example 250C (cyan), 260M (magenta), 270Y (yellow) or 352K (black). In some cases, the light absorbing (e.g., pigment) particles 507 are surface treated to impart ionizable functionality. Examples of suitable ionizable functionality for the light absorbing particles 507 include sulfonate functionality, carboxylate functionality as well as phosphate or bisphosphonate functionality. In some embodiments, surface treated light absorbing (e.g., pigment) particles having ionizable functionality are commercially available. For example, CAB-O-JET® pigments, commercially available from Cabot Corporation, sold under the trade names 250C (cyan), 260M (magenta), 270Y (yellow) and 200 (black), comprise sulfonate functionality. CABO-JET® pigments commercially available from Cabot Corporation, under the trade names 352K (black) and 300 (black), comprise carboxylate functionality.

In some case, multiple light absorbing materials (e.g., pigments) may be utilized to achieve a specific hue or shade or color in the final product. When multiple light absorbing materials (e.g., pigments) are used, the materials are selected to ensure their compatibility and performance both with each other and with the optical product components.

In some embodiments, a median particle size of the light absorbing particles 507 is generally less than 1 micron. In some cases, the median particle size is no greater than 900, 800, 700, 600, or 500 nm. In some cases, the median particle size is no greater than 450, 400, 350, 300, 250, 200, or 100 nm. In some cases, the median particle size is no greater than 90, 85, 80, 75, 70, 65, 60, 55, or 50 nm. In some cases, the median particle size is no greater than 30, 25, 20, or 15 nm. The median particle size is typically at least 1, 2, 3, 4, or 5 nanometers. In some embodiments, the light absorbing particles 507 may be nanoparticles. The particle size of the nanoparticles of the absorptive regions can be measured using transmission electron microscopy or scanning electron microscopy. In some embodiments, the light absorbing particles 507 have an average particle size of at least 20 nm. In some embodiments, the light absorbing particles 507 have an average particle size of less than 1 micron.

In some embodiments, the light absorbing particles 507 are present in a concentration of at least 1 wt. % based on the total weight of the water-based coating. In some other embodiments, the concentration of the light absorbing particles 507 is at least 2, 3, 4, 6, 8, 10, 15, 20, 25, 30, 35, 40, 45, or 50 wt. % of the total weight of the water-based coating. In some other embodiments, the concentration of the light absorbing particles 507 is less than 50, 40, 30, 20, 10, or 5 wt. % of the total weight of the water-based coating. The concentration of the light absorbing particles 507 in the water-based coating can be determined by any method known in the art, such as thermogravimetric analysis.

In some aspects, the coating method may include, for example, spin-coating, bar coating, screen printing, ink jet printing, slit die coating, flood coating, and the like. Alternatively, each channel 502 of the microstructured film 500 can be filled with the water-based coating solution.

Further, as shown in FIG. 3C, the water-based coating further includes a drying step that leads to selective coating of the side surfaces 504 of each light transmissive region 501. The top surface 503 of the light transmissive region 501 and the bottom surface 505 of the channel 502 are devoid of light absorbing particles. Typically, the step of drying can be achieved by any conventional drying techniques known in the art. More particularly, the drying can be achieved by at least one of air drying, infra-red drying, and oven drying. In some cases, the step of drying may be achieved at a room temperature. In some cases, the drying is achieved at a temperature of at least 40, 50, 60, 70, 80, 90, 100° C. or more. Alternatively, the drying can be achieved by using infrared heaters. In some cases, during the step of drying the water-based coating, an air flow 509 may be provided substantially parallel to the channels 502 of the microstructured film 500 such that the airflow does not disturb the liquid. Due to drying, a coating of the light absorbing particles 507 may form on the side surfaces 504. The coating may progress downwards along the side surfaces 504.

Referring to FIG. 3D, the microstructured film 500 that is selectively coated is illustrated. More particularly, a coating 508 is formed on the side surfaces 504 of each light transmissive region 501. The coating 508 may be formed by drying of the water-based coating leading to the deposition of the light absorbing particles 507 on the side surfaces 504, as shown in FIG. 3C. A thickness of the coating 508 on the side surfaces 504 of the light transmissive region 501 is at least 0.1 μm. Further, the top surface 503 of each light transmissive region 501 and bottom surface 505 of each channel 502 are devoid of any coating of the light absorbing particles 507.

As depicted in FIG. 3E, the microstructured film 500 includes the plurality of light transmissive regions 501 and the light absorbing regions formed by the coating 508. Each channel 502 (shown in FIG. 3D) is filled with a material similar to the material of the light transmissive regions 501. Specifically, each channel 502 is backfilled with a material similar to the material of light transmissive regions 501 to form light transmissive regions 510. In some cases, the material includes an organic polymeric material, such as a polymerizable resin that is curable. Each light transmissive region 510 is disposed between two light absorbing regions formed by the coating 508. The microstructured film 500 may therefore include alternative light transmissive regions 501, 510 and light absorbing regions formed by the coating 508. Thus, the microstructured film 500, as shown in FIG. 3E, is a light control film.

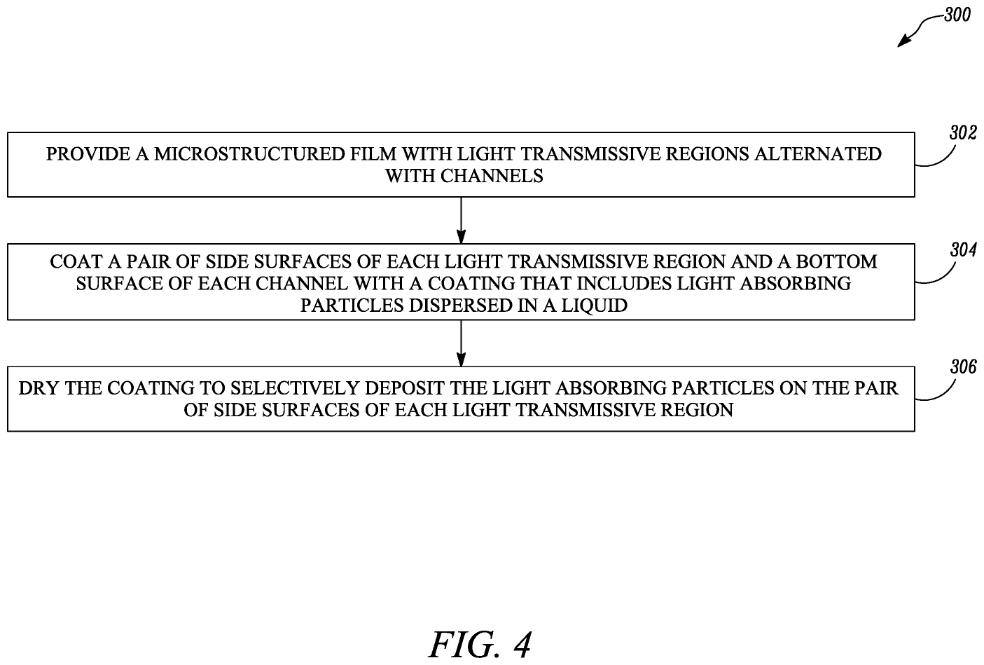

Referring to FIG. 4, a method 300 for manufacturing a light control film. The method 300 will be described with reference to FIGS. 3A-3E.

At step 302, the method includes providing the microstructured film 500. The microstructured film 500 includes the plurality of light transmissive regions 501, alternated with the plurality of channels 502. Each of the light transmissive region 501 includes the top surface 503 and the pair of side surfaces 504 extending from the top surface 503. Each channel 502 includes the bottom surface 505. The surface of the microstructured film 500 is defined by the top surface 503, the side surface 504 and the bottom surface 505.

In some cases, the method further includes performing a surface treatment on the surface of microstructured film 500. More preferably, the surface treatment includes at least one of oxygen plasma treatment, corona treatment, and fluorocarbon plasma treatment. In some other cases, the microstructured film 500 is devoid of any surface plasma treatment.

At step 304, the method 300 further includes coating the side surfaces 504 of each light transmissive region 501 and the bottom surface 505 of each channel 502 with the coating. In some embodiment, the coating is the water-based coating. The water-based coating includes the light absorbing particles 507 that are dispersed in water.

In some cases, the coating further includes an additive. In some cases, the additive includes at least one of a binder, a surfactant, and a cross-linker. In some cases, the light absorbing particles are present in a concentration of at least 1 wt. % based on the total weight of the coating.

At step 306, the method 300 further includes drying the coating such that the light absorbing particles 507 are selectively deposited on the pair of sides surfaces 504 of each light transmissive region 501.

In some cases, the drying of the coating includes at least one of air drying, infra-red heating, and oven drying. In some cases, the drying is achieved at a temperature of at least 50° C.

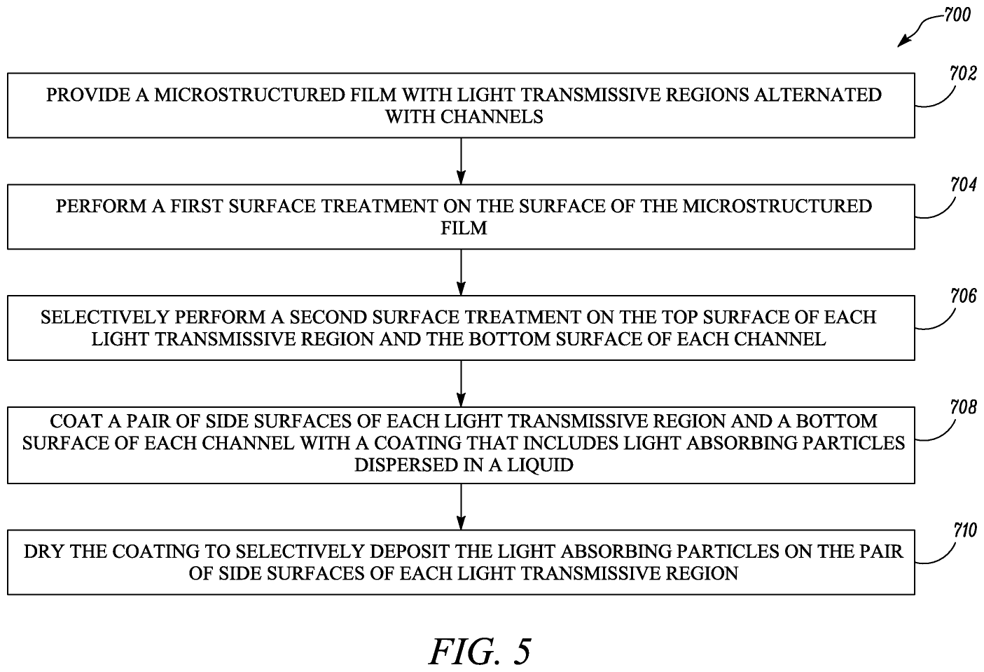

Referring to FIG. 5, a method 700 for manufacturing a light control film. The method 700 will be described with reference to FIGS. 3A-3E.

At step 702, the method 700 involves providing the microstructured film 500. The microstructured film 500 includes the plurality of light transmissive regions 501, alternated with the plurality of channels 502. Each of the light transmissive region 501 includes the top surface 503 and the pair of side surfaces 504 extending from the top surface 503. Each channel 502 includes the bottom surface 505. The surface of the microstructured film 500 is defined by the top surface 503, the side surface 504 and the bottom surface 505.

At step 704, the method 700 includes performing a first surface treatment on the surface of the microstructured film 500. In some embodiments, the first surface treatment includes a plasma treatment method. In some embodiments, the first surface treatment includes at least one of oxygen plasma treatment or corona treatment.

At step 706, the method 700 includes selectively performing a second surface treatment on the top surface 503 of each light transmissive region 501 and the bottom surface 505 of each channel 501. In some embodiments, the second surface plasma treatment includes fluorocarbon plasma treatment.

At step 708, the method 700 further includes coating the surface treated microstructured film 500 with the water-based coating that includes the light absorbing particles 507.

In some cases, the light absorbing particles 507 are present in a concentration of at least 1 wt. % based on the total weight of the water-based coating.

In some aspects, the water-based coating may include an additive. In some cases, the additive includes at least one of a binder, a surfactant, and a cross-linker. In some cases, the binder may include at least one of an anionic binder, a cationic binder, and a zwitterionic binder.

At step 710, the method 700 includes drying the water-based coating such that the light absorbing particles 507 are selectively deposited on the pair of sides surfaces 504 of each light transmissive region 501.

In some cases, the water-based coating is achieved at a temperature of at least 50° C. In some cases, drying the water-based coating includes at least one of air drying, infra-red heating, and oven drying.

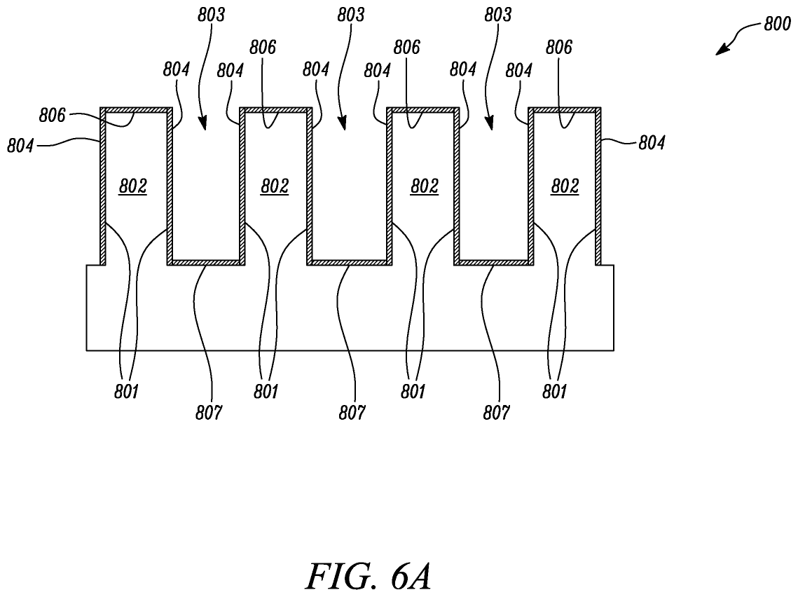

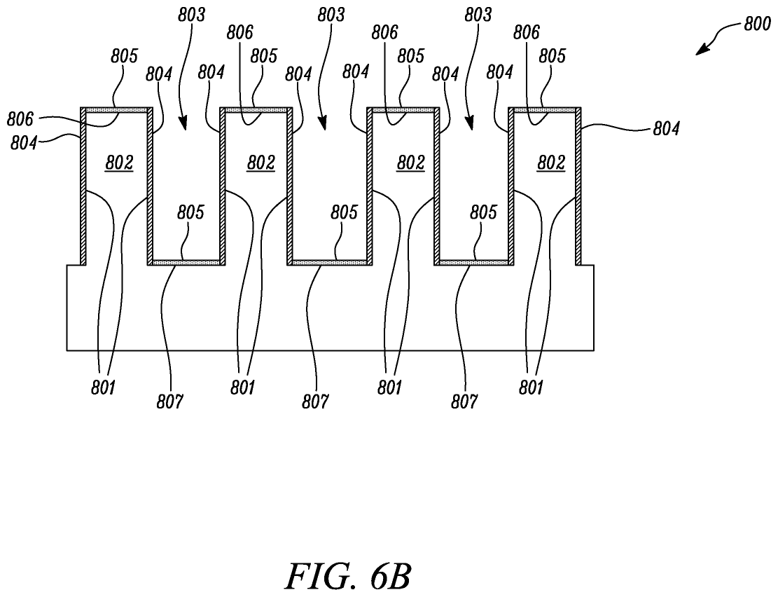

Referring to FIGS. 6A and 6B, a method of performing a surface treatment on the surface of a microstructured film 800 is illustrated. Referring to FIG. 6A, the method includes manufacturing the microstructured film 800 including a plurality of light transmissive regions 802. A channel 803 is defined between adjacent light transmissive regions 802. Each light transmissive region 802 has a top surface 806 and a pair of side surfaces 801. Each channel 803 has a bottom surface 807. The microstructured film 800 is subjected to a surface treatment. A surface of the microstructured film 800 is defined by the top surface 806 and the side surfaces 801 of each light transmissive region 802, and the bottom surface 807 of each channel 803. The surface of the microstructured film 800 is treated by a first surface treatment. In some embodiments, the microstructured film 800 is treated with oxygen plasma. Due to the oxygen plasma treatment, the surface of the microstructured film 800 becomes more hydrophilic and is indicated by a high energy surface 804. In some other embodiments, the first surface treatment may be corona treatment.

Referring to FIG. 6B, the microstructured film 800 is selectively treated with a second surface treatment. In some embodiments, the microstructured film 800 is selectively treated with fluorocarbon (FC) plasma treatment. The FC plasma treatment is selectively applied on the top surface 806 of each light transmissive region 802 and the bottom surface 807 of each channel 803. Due to the FC plasma treatment, the top surface 806 and the bottom surface 807 of the channels becomes more hydrophobic and is indicated by a low energy surface 805. Due to selective treatment, the side surfaces 801 continue to have the high energy surface 804.

Further, in some embodiments, the method includes coating of the light transmissive region 802 with a water-based coating. The method further includes drying of the water-based coating. In some cases, drying the water-based coating includes at least one of air drying, infra-red heating, and oven drying. In some cases, the water-based coating is achieved at a temperature of at least 50° C.

The present disclosure further illustrated by the following examples, but the particular materials and amounts thereof recited in these examples, as well as other conditions and details, should not be construed to unduly limit this disclosure.

### EXAMPLES

Unless otherwise noted, all parts, percentages, ratios, etc., in the examples and in the remainder of the specification are by weight. The following is a list of materials used throughout the Examples, as well as their brief descriptions and origins.

The components of Resin A used in the cast-and-cure microreplication process are listed in Table 1 below. Resin A may be used for the fabrication of the microstructured films 100, 200, 500.

TABLE 1
provides Raw materials for Resin A as given below.

| Material | Abbreviation | Source |
|---|---|---|
| Aliphatic urethane diacrylate | Photomer 6010 | BASF |
| Viscosity 5900 mPa · s at 60° C. | | |
| Tensile Strength 2060 psi | | |
| Tg = −7° C. | | |
| Ethoxylated (10) bisphenol A | SR602 | Sartomer (Exton, PA) |
| Diacrylate | | |
| Ethoxylated (4) bisphenol A | SR601 | Sartomer (Exton, PA) |
| Diacrylate | | |
| Trimethylolpropane triacrylate | TMPTA | Cytec Industries (Woodland |
| | | Park, NJ) |
| Phenoxyethyl Acrylate | PEA (Etermer 2010) | Eternal Chemical Co., Ltd., |
| | | Kaohsiung, Taiwan |
| 2-Hydroxy-2- | Darocur 1173 | BASF Corporation (Florham |
| methylpropiophenone | | Park, New Jersey) |
| photoinitiator | | |
| Diphenyl(2,4,6- | TPO | BASF Corporation (Florham |
| trimethylbenzoyl)phosphine | | Park, New Jersey) |
| oxide photoinitiator | | |
| Irgacure 1035 anti-oxidant | I1035 | BASF Corporation (Florham |
| | | Park, New Jersey) |

### Example 1

Preparation of “Square Wave” Microstructured Film

This example can be used for manufacturing the microstructured films 100, 200, 500.

A diamond (29.0 μm tip width, 3° included angle, 87 μm deep) was used to cut a tool having a plurality of parallel linear grooves. The grooves were spaced apart by a pitch of 62.6 microns.

Resin A was prepared by mixing the materials in Table 2 below.

TABLE 2
Composition of Resin A used to make microstructured film

| Material | Parts by Weight |
|---|---|
| Photomer 6010 | 60 |
| SR602 | 20 |
| SR601 | 4.0 |
| TMPTA | 8.0 |
| PEA (Etermer 2010) | 8.0 |
| Darocur 1173 | 0.35 |
| TPO | 0.10 |
| I1035 | 0.20 |

A “cast-and-cure” microreplication process was carried out with Resin A and the tool described above. The microstructured film were made by molding and ultraviolet (UV) light curing a resin A mixture as described in Table 1 on 0.007 inches (0.178 mm) polycarbonate (PC) film.

The line conditions were: resin temperature 150° F., die temperature 150° F., coater IR 120° F. edges/130° F. center, tool temperature 100° F., and line speed 70 fpm. Fusion D lamps, with peak wavelength at 385 nm, were used for curing and operated at 100% power. For these structured films, a cylindrical-shaped metal roll with finely detailed channels cut into its outer surface served as the mold. The resinous mixture was first coated onto a PC substrate film, and then pressed firmly against the metal roll in order to completely fill the mold. Upon polymerization the structured film was removed from the mold.

The resulting microstructured film included a plurality of protrusions (e.g., light transmissive regions 230) separated by channels (e.g., channels 201, shown in FIG. 2). The protrusions of the microstructured film are a negative replication of the grooves of the tool. The protrusions have a wall angle of 1.5 degrees resulting in the protrusions being slightly tapered (wider at the light input surface and narrower at the light output surface). The channels of the microstructured film are a negative replication of the uncut portions of the tool between the grooves.

### Example 2

Method of Manufacturing Light Control Films with or without Surface Treatment

A microstructured film similar to microstructured films 100, 200, 500 is provided.

TABLE 3
Resin B composition

| Material | Parts by Weight |
|---|---|
| Bis-A Diacrylate | 75 |
| Diluent | 25 |

The microstructured film has a 3:1 structure (30 μm wide, 90 μm deep) made with Resin B. The composition of Resin B is provided in Table 3 above. Resin B was prepared by blending the monomers in the ratios specified above in Table 3. The diluent included one or more (meth)acrylate diluents.

The coating solution was approximately 1% Cabojet-200 carbon black, 0.06% Tomadol 25-9 surfactant, and 0.04% Neocryl A639 acrylic dispersion in water. This solution was applied to the microstructured film by airbrush until a sheen was observed on the film (indicating that the channels were full). The sample was then dried in a batch oven at 80° C. On and off-axis % transmission (% T) data was taken by a Hazegard Plus transparency meter at 0 degrees and approximately 35 degrees. Table 4 provides percentage transmission of plasma treated microstructured film and microstructured film devoid of plasma treatment.

TABLE 4
Transmission (% T) of plasma treated microstructured film and
microstructured film devoid of plasma treatment

| Type of Microstructured film | 35 deg % T | 0 deg % T |
|---|---|---|
| FC/O₂ plasma Verde film | 1.4 | 88.0 |
| Verde film, no treatment | 0.8 | 86.1 |

### Example 3

Transmission of Light Control Films with Water-Based Coating.

A microstructured film (e.g., microstructured films 100, 200, 500, and 800) are coated with water-based coating solutions. Various compositions of water-based coating solution are tabulated in Table 5.

TABLE 5
Water-based coating compositions

| | | CABOJET | | |
|---|---|---|---|---|
| | | Carbon | Neocryl | |
| Sample | CX-100 | Black | A639 | Tomadol 25-9 |
| 1 | 0.000% | 1.60%^{∧} | 0.00% | 0.20% |
| 2 | 0.000% | 1.60%^{∧} | 0.048% | 0.20% |
| 3 | 0.320% | 1.60%* | 0.20% | 0.20% |

Note:
CABOJET Carbon black used in the composition: ^{∧}indicates Cabojet 200; *indicates Cabojet 300.

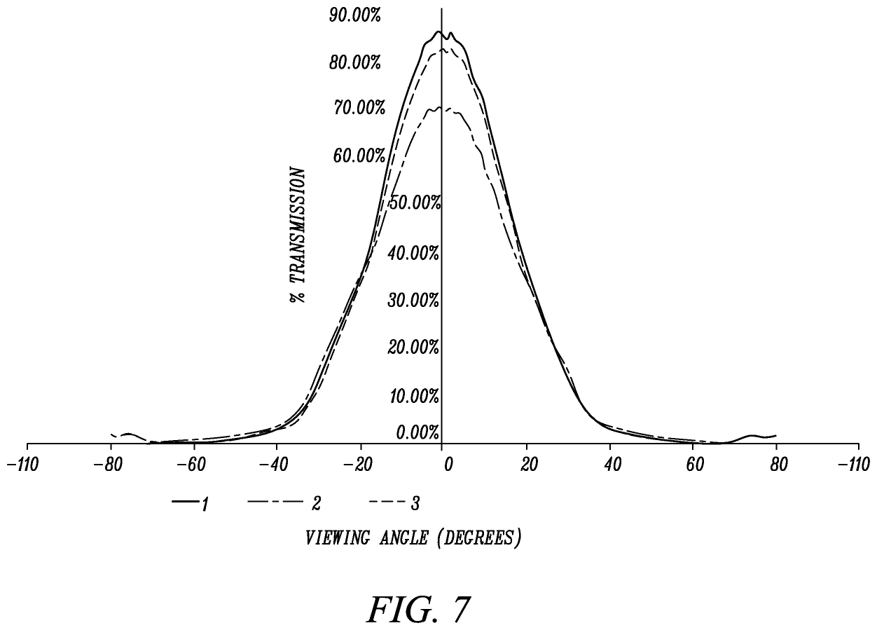

Referring to FIG. 7, a plot of transmission (%) as a function of viewing angle for various coating compositions in Table 5 is provided. As shown in FIG. 7, Sample 1 has the highest transmission at normal incidence followed by Sample 3 and Sample 2.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

While the invention has been described in connection with certain embodiments, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A method of manufacturing a light control film, the method comprising:
providing a microstructured film comprising a plurality of light transmissive regions alternated with channels, wherein the microstructured film has a surface defined by a top surface and a pair of side surfaces of each light transmissive region and a bottom surface of each channel;
coating the pair of side surfaces of each light transmissive region and the bottom surface of each channel with a coating, the coating comprising light absorbing particles dispersed in a liquid; and
drying the coating such that the light absorbing particles are selectively deposited on the pair of sides surfaces of each light transmissive region.

2. The method of claim 1, wherein the coating is a water-based coating and the liquid is water.

3. The method of claim 1, wherein the top surface of each light transmissive region and the bottom surface of each channel are devoid of the light absorbing particles.

4. The method of claim 1, wherein the light absorbing particles have an average particle size of at least 20 nm.

5. The method of claim 1, wherein the light absorbing particles have an average particle size of less than 1 micron.

6. The method of claim 1, wherein the drying of coating comprises at least one of air drying, infra-red heating, and oven drying.

7. The method of claim 1, wherein the drying of the coating is achieved at a temperature of at least 50° C.

8. The method of claim 1, further comprising performing a surface treatment on the surface of the microstructured film.

9. The method of claim 8, wherein the surface treatment comprises at least one of oxygen plasma treatment, corona treatment, and fluorocarbon plasma treatment.

10. The method of claim 1, wherein the microstructured film is devoid of any surface treatment.

11. The method of claim 1, further comprising filling the channels with a material similar to a material of the light transmissive regions.

12. The method of claim 1, wherein the coating further comprises an additive.

13. The method of claim 12, wherein the additive comprises at least one of a binder, a surfactant, and a cross-linker.

14. The method of claim 13, the binder comprises at least one of an anionic binder, a cationic binder, and a zwitterionic binder.

15. The method of claim 1, wherein the light absorbing particles comprise carbon black particles.

16. The method of claim 1, wherein the light absorbing particles are present in a concentration of at least 1 wt. % based on the total weight of the coating.

17. The method of claim 1, wherein the microstructured film further comprises a base layer, the light transmissive regions extending from the base layer.

18. The method of claim 1, wherein the microstructured film comprises a polymerizable resin.

19. A method of manufacturing a light control film, the method comprising:
providing a microstructured film comprising a plurality of light transmissive regions alternated with channels, wherein the microstructured film has a surface defined by a top surface and a pair of side surfaces of each light transmissive region and a bottom surface of each channel;
performing a first surface treatment on the surface of the microstructured film;
selectively performing a second surface treatment on the top surface of each light transmissive region and the bottom surface of each channel;
coating the pair of side surfaces of each light transmissive region and the bottom surface of each channel with a coating, the coating comprising light absorbing particles dispersed in a liquid; and
drying the coating such that the light absorbing particles are selectively deposited on the pair of side surfaces of each light transmissive region.

20-24. (canceled)
